(19) United States
(12) Patent Application Publication
(10) Pub. No.: US 2022/0122316 A1
(43) Pub. Date: Apr. 21, 2022

(54) POINT CLOUD CREATION

(71) Applicant: HERE Global B.V., Eindhoven (NL)

(72) Inventors: Landis Huffman, Chicago, IL (US); Josh Finken, Park City, UT (US); Amey Aroskar, North Aurora, IL (US); Sumedh Rasal, Chicago, IL (US)

(21) Appl. No.: 17/074,452

(22) Filed: Oct. 19, 2020

(51) Int. Cl. G06T 17/00; G01S 17/89

(52) U.S. Cl. CPC G06T 17/00; G06T 2207/10044; G06T 2207/10028; G01S 17/89

(57) ABSTRACT

An apparatus includes at least one memory, a feature extractor, an image matcher, and a mapper. The memory stores images corresponding to a geographic area, and the images include image descriptors adaptable into a spatial relationship based on positional information. The feature extractor is configured to select a set of neighboring images from the images using a pairing factor. The image matcher is configured to calculate point matches based on the set of neighboring images and the positional information. The mapper is configured to construct a three-dimensional point cloud for at least a portion of the geographic area, from the point matches, using the image descriptors from the set of neighboring images.

### FIELD

The following disclosure relates to the construction, or modification, of point clouds to represent a geographic area where the point clouds are, at least in part, based on two-dimensional images.

### BACKGROUND

The Global Positioning System (GPS) or another global navigation satellite system (GNSS) provides location information to a receiving device anywhere on Earth as long as the device has a substantial line of sight without significant obstruction to three or four satellites of the system. The GPS system is maintained and made available by the United States government. Originally, the government retained exclusive use of GPS. Over time increasing levels of accuracy of the GPS signals were made available to the public.

Accuracy of the GPS system alone is about 50 feet or 15 meters. The accuracy may be augmented using secondary techniques or systems such as the Wide Area Augmentation System (WAAS), Differential GPS (DGPS), inertial navigation systems (INS) and Assisted GPS. WAAS and DGPS improve accuracy using ground stations that transmit position information. INS utilizes internal sensors at the receiving device for improving the accuracy of GPS.

However, some applications require greater accuracies obtainable with GPS, even with enhanced accuracy techniques. For example, in high definition mapping and navigating application, the receiving device may be placed on a map in a three-dimensional view with greater accuracy than that obtainable from GPS techniques. Localization techniques that match a location to a map or environment face additional challenging in improving this accuracy.

### SUMMARY

In one embodiment, a method for three-dimensional point cloud generation includes identifying a plurality of images corresponding to a geographic area and including image descriptors, wherein two or more of the plurality of images adaptable into a spatial relationship based on positional information associated with the plurality of images, selecting a set of neighboring images from the plurality of images using a pairing factor, calculating, using a processor, point matches within the set of neighboring images based on the image descriptors, and constructing, using the processor, a three-dimensional point cloud for at least a portion of the geographic area, from the point matches and the spatial relationship, using the image descriptors from the set of neighboring images.

In one embodiment, an apparatus includes a memory including a plurality of images corresponding to a geographic area, wherein the plurality of images include image descriptors adaptable into a spatial relationship based on positional information associated with the plurality of images, a feature extractor configured to select a set of neighboring images from the plurality of images using a pairing factor, an image module configured to calculate point matches based on the set of neighboring images and the positional information, and a mapper configured to construct a three-dimensional point cloud for at least a portion of the geographic area, from the point matches, using the image descriptors from the set of neighboring images.

In one embodiment, a non-transitory computer readable medium including instructions that when executed are configured to perform identifying a plurality of images corresponding to a geographic area, wherein the plurality of images include image descriptors adaptable into a spatial relationship based on positional information associated with the plurality of images, selecting a set of neighboring images from the plurality of images using a pairing factor, calculating point matches based on the set of neighboring images and the positional information, constructing a three-dimensional point cloud for at least a portion of the geographic area, from the point matches, using the image descriptors from the set of neighboring images, receiving sensor data from a mobile device, and calculating a position based on the sensor data and the three-dimensional point cloud.

### BRIEF DESCRIPTIONS OF THE DRAWINGS

Exemplary embodiments of the present invention are described herein with reference to the following drawings.

FIG. 1 illustrates an example system for point cloud creation.

FIG. 2 illustrates a first embodiment of a point cloud generator and/or controller for the system of FIG. 1.

FIG. 3 illustrates a second embodiment of a point cloud controller for the system of FIG. 1.

FIG. 4 illustrates an example server for the system of FIG. 1.

FIG. 5 illustrates an example flow chart for the server of FIG. 4.

FIG. 6 illustrates an example mobile device for the system of FIG. 1.

FIG. 7 illustrates an example flow chart for the mobile device of FIG. 6.

FIG. 8 illustrates exemplary vehicles for the system of FIG. 1.

### DETAILED DESCRIPTION

Localization is the is a term that encompasses various techniques for calculating the position and orientation of a user device or associated device. GNSS is one example but has shortfalls. For example, GNSS relies on the timing of radio signals from satellites and the radio signal may be affected by reflections from buildings or other objects on the transmission to the user or associated device. Various systems have been developed for localization as an alternative to GNSS or to supplement GNSS.

A visual positioning service (VPS) includes an automated algorithm for estimating the position and orientation, which may be referred to as the pose, of a mobile device using an image, which may be captured from a camera of the mobile device. VPS provides an alternative to GNSS, providing accurate position estimates in GNSS-constrained areas such as indoors or dense urban canyons. Even when reliable GNSS is available, VPS can augment GNSS for more accurate positioning. Furthermore, VPS provides an estimate for camera orientation, which GNSS cannot. At least one of the following embodiments include a VPS system that can estimate position with sub-meter accuracy (e.g., accuracy to 10-80 cm) with near-real-time processing (e.g., real time with or without a nominal delay such as 1-100 milliseconds). The estimated position improves a variety of technologies including collision avoidance and other driving assistance systems and autonomous vehicles.

Another technology improved by the following embodiments is augmented reality (AR). AR applications for navigation may be improved by aligning the camera imagery to the real world. AR and VPS may transform how consumers utilize navigation. Users may experience AR on their mobile screen as overlays of route information, displays of nearby restaurants and POIs, and three-dimensional (3D) scene models could allow the user to see objects through walls.

In some examples, VPS estimates a camera pose by comparing point features extracted from a query image to those in a reference 3D point cloud model of the scene. The 3D point cloud is a visual representation of the scene built from many source images. It is comprised of a dense set of 3D point coordinates, where each point also stores a visual descriptor that encodes the photographed appearance of that point in one or more of the source images.

A VPS system may utilize a 3D point cloud, where each point in the cloud has a 3D coordinate (latitude, longitude, altitude) and a visual descriptor derived from one or more source images. This point cloud is constructed offline using dozens to hundreds of images from possibly many data sources, including light detection and ranging (LIDAR), video, or web imagery. Mixing many different data sources into a single, geometrically consistent point cloud is a challenging problem which is addressed by the following embodiments.

Many imagery data sources, such as video and web imagery, provide only 2D pixel data and possibly (latitude, longitude) coordinates of the cameras position at the time of capture. The additional structure of the photographed scene must be inferred from the imagery from multiple poses. One technique, Structure from Motion (SfM), may be leveraged to convert a set of images of a static scene to a 3D point cloud with encoded visual descriptors at each point. The colmap (COLMAP) codebase is one example of a database utilized to achieve this conversion of images to a 3D point cloud. The COLMAP database provides many subroutines and utilities that can be applied to process source imagery. The conversion of images to the 3D point cloud is complex and computer resource and processing time intensive. In addition, the results using the COLMAP database and related processes may result in a 3D point cloud with low accuracy in some situations. The following embodiments include techniques to improve the speed, accuracy, and computer resources required to convert images to a 3D point cloud.

The following embodiments also relate to several technological fields including but not limited to navigation, autonomous driving, assisted driving, traffic applications, and other location-based systems. The following embodiments achieve advantages in each of these technologies because an improved point cloud improves the accuracy of each of these technologies. In each of the technologies of navigation, autonomous driving, assisted driving, traffic applications, and other location-based systems, the number of users that can be adequately served is increased. In addition, users of navigation, autonomous driving, assisted driving, traffic applications, and other location-based systems are more willing to adopt these systems given the technological advances in accuracy and speed.

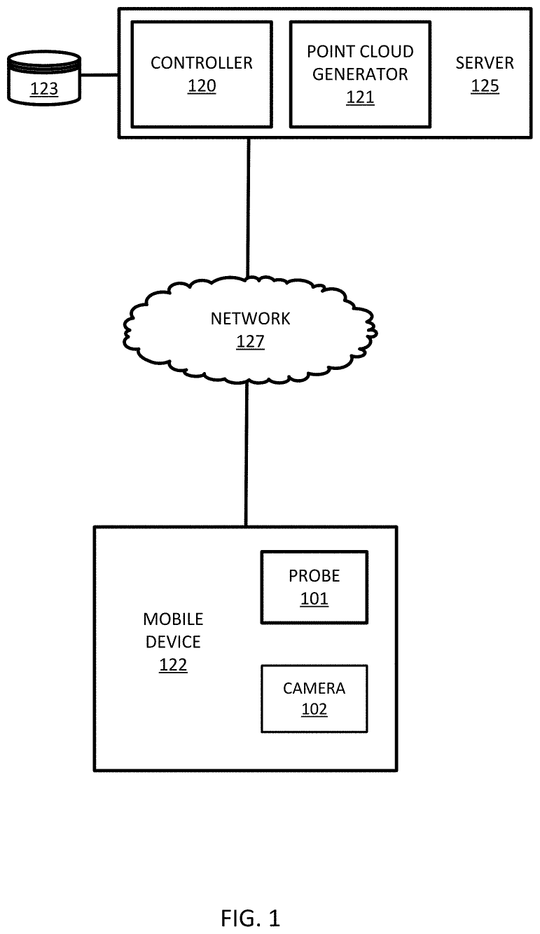

FIG. 1 illustrates an example system for point cloud creation including a mobile device 122, a server 125, and a network 127. Additional, different, or fewer components may be included in the system. The following embodiments may be entirely or substantially performed at the server 125, or the following embodiments may be entirely or substantially performed at the mobile device 122. In some examples, some aspects are performed at the mobile device 122 and other aspects are performed at the server 125.

The mobile device 122 may include a probe 101 or position circuitry such as one or more processors or circuits for generating probe data. The probe points are based on sequences of sensor measurements of the probe devices collected in the geographic region. The probe data may be generated by receiving GNSS signals and comparing the GNSS signals to a clock to determine the absolute or relative position of the mobile device 122. The probe data may be generated by receiving radio signals or wireless signals (e.g., cellular signals, the family of protocols known as WiFi or IEEE 802.11, the family of protocols known as Bluetooth, or another protocol) and comparing the signals to a pre-stored pattern of signals (e.g., radio map). The mobile device 122 may act as the probe 101 for determining the position or the mobile device 122 and the probe 101 may be separate devices.

The probe data may include a geographic location such as a longitude value and a latitude value. In addition, the probe data may include a height or altitude. The probe data may be collected over time and include timestamps. In some examples, the probe data is collected at a predetermined time interval (e.g., every second, every 100 milliseconds, or another interval). In this case, there are additional fields like speed and heading based on the movement (i.e., the probe reports location information when the probe 101 moves a threshold distance). The predetermined time interval for generating the probe data may be specified by an application or by the user. The interval for providing the probe data from the mobile device 122 to the server 125 may be the same or different than the interval for collecting the probe data. The interval may be specified by an application or by the user.

Communication between the mobile device 122 and the server 125 through the network 127 may use a variety of types of wireless networks. Some of the wireless networks may include radio frequency communication. Example wireless networks include cellular networks, the family of protocols known as WiFi or IEEE 802.11, the family of protocols known as Bluetooth, or another protocol. The cellular technologies may be analog advanced mobile phone system (AMPS), the global system for mobile communication (GSM), third generation partnership project (3GPP), code division multiple access (CDMA), personal handy-phone system (PHS), and 4G or long term evolution (LTE) standards, 5G, DSRC (dedicated short range communication), or another protocol.

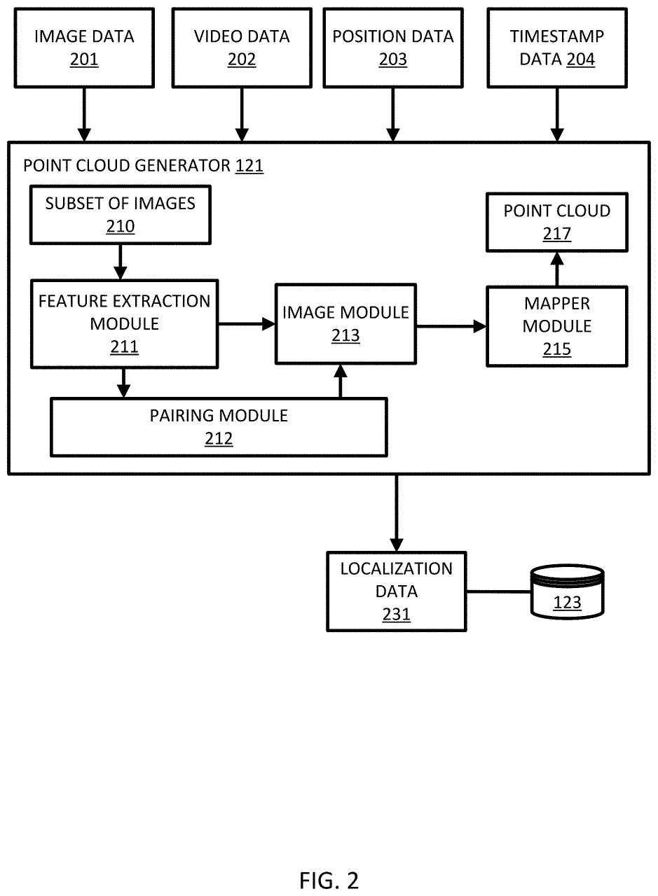

FIG. 2 illustrates a first embodiment of a point cloud generator 121, which may be implemented separately or integrated with controller 120, for the system of FIG. 1. While FIG. 1 illustrates the point cloud generator 121 at server 125, the mobile device 122 may also implement the point cloud generator 121. Additional, different, or fewer components may be included.

The point cloud generator 121 may include a feature extraction module 211, a pairing module 212, a image module 213, and a mapper module 215. Other computer architecture arrangements for the point cloud generator 121 may be used.

The point cloud generator 121 receives data from one or more sources. The data sources may include image data 201, video data 202, position data 203, and timestamp data 204. The image data 201 may include a set of images collected by the mobile device 122, for example by camera 102. Likewise, the video data 202 may include a series of images in a video collected by the mobile device 122, for example by camera 102. The image data 201 and/or video data 202 may be collected by a camera coupled to a vehicle and/or associated with the mobile device 122.

The image data 201 and/or video data 202 may be aggregated from multiple mobile devices. The image data 201 and/or video data 202 may be aggregated across a particular service, platform, and application. For example, multiple mobile devices may be in communication with a platform server associated with a particular entity. For example, a vehicle manufacturer may collect video from various vehicles and aggregate the videos as video data 202. In another example, a map provider may collect image data 201 and/or video data 202 using an application (e.g., navigation application, mapping application running) running on the mobile device 122.

The image data 201 and/or video data 202 may be user selected data. That is, the user of the mobile device 122 may select when and where to collect the image data 201 and/or video data 202. For example, the user may collect image data 201 and/or video data 202 for the purpose of personal photographs or movies. Alternatively, the user may be prompted to collect the image data 201 and/or video data 202.

The image data 201 and/or video data 202 may be collected from vehicles. For example, a vehicle may include a camera that collects images of the surrounding area. The images may be collected for the purpose of detecting objects in the vicinity of the vehicle, determining the position of the vehicle, or providing automated driving or assisted driving.

The image data 201 and/or video data 202 may be derived from other sources. For example, images may be collected from the internet. The images may be collected from a web search (e.g., reverse image search or text search). The images may be collected from a social media or sharing services (e.g., according to keyword).

In any of these examples, the images may be collected based on geocodes associates with the images. For example, a vehicle manufacturer, an individual user of the mobile device 122, or an application administrator, may index or store images according to geocodes describing the geographical location from where the images were collected. The geocode may include geographic coordinates (e.g., latitude and longitude). The geocodes may include country, regional, or local identifiers for the location. The geocodes are one example of position data 203. However, the position data 203 may include any type of position information and may be determined by the mobile device 122 and stored by the mobile device 122 in response to collection of the image data 201. The position data 203 may include geographic coordinates and at least one angle that describes the viewing angle for the associated image data. The at least one angle may be calculated or derived from the position information and/or the relative size of objects in the image as compared to other images.

The timestamp data 204 may be stored along with or otherwise associated with image data 201 and/or video data 202. The timestamp data 204 may include data indicative of a specific time (e.g., year, month, day, hour, minute, second, etc.) that the image data 201 and/or video data 202 were collected by the mobile device 122 or another device.

The subset of images 210 provided to the point cloud generator 121 includes information from one or more of these data sources. The is the subset of images 210 includes at least one of and any combination of image data 201, video data 202, position data 203, and timestamp data 204. For example, the subset of images 210 may include two-dimensional images collected by the mobile device 122 and associated with position information and timestamp information.

The subset of images 210, which may be associated with a geographic area according to the position information and/or associated with the timestamp information, may be stored by a memory for the point cloud generator 121. The images may be stored in a predetermined image format including one or more fields for the image data, one or more fields for the position information, and one or more fields for the timestamp information.

The feature extraction module 211, or feature extractor, is configured to analyze the subset of images 210. The subset of images 210 may also be associated with one or more image descriptors based on an image processing algorithm. The image descriptors may be identified or determined by the feature extraction module 211 of the point cloud generator 121. The image descriptors may be visual descriptors including one or more values that encode the photographed appearance of that point in the image. The image descriptors are quantitative characterization of the image that may be different from the image itself. The image descriptors may include the results of an analysis of the image. In one example, a window or subset of each image is analyzed to determine a numerical value for the image descriptor. The window may be iteratively slid across the image according to a step size in order to analyze the image. The image descriptor may be a binary value that indicates whether or not the image data in the window matches a particular template or set of templates. For example, in feature detection, the image descriptor may indicate whether a particular feature is found in the window. In another example, the numerical value, or combination of numerical values for the image descriptor may describe what type of feature is included in the window. Example features may include edges, surfaces, foreground features, background features or other high level indicators. Edge detection identifies changes in brightness, which corresponds to discontinuities in depth, materials, or surfaces in the image. Object recognition identifies an object in an image using a set of templates for possible objects. The template accounts for variations in the same object based on lighting, viewing direction, and/or size.

In one example, the image descriptors could be based on scale-invariant feature transform (SIFT). SIFT may perform a specific type of feature extraction that identifies feature vectors in the images and compares pairs of feature vectors. The feature vectors may be compared based on direction and length. The feature vectors may be compared based on the distance between pairs of vectors. The feature vectors may be organized statistically, such as in a histogram. The statistical organization may sort the image descriptors according to edge direction, a pixel gradient across the image window, or another image characteristic. As described in more detail below, the image descriptors are adaptable into a spatial relationship based on positional information associated with the subset of images 210. The positional information may include position coordinates and/or heading values.

The feature extraction module 211 provide the image descriptors to the image module 213. While all of the images and image descriptors may be provided to the image module 213, an exhaustive pairing of the images and associated image descriptors for feature matching is not used. An exhaustive pairing is when all combinations, or substantially all combinations, are used.

Instead, the pairing module 212 limits the pairing of the images and/or associated image descriptors. The pairing module 212 select specific pairs of the subset of images 210, or associated image descriptors, from the point cloud generator 121 using a pairing factor. The pairing factor may include one or more neighboring criteria of neighboring filters for limiting the received images to the subset of images 210. The neighboring filter may include a limiting factor that is temporal and/or a limiting factor that is geographic. When the limiting factor is geographic it may be based on position and/or heading.

The pairing module 212 is configured to iteratively examine potential combinations of images by identifying an initial image (image0) and comparing the initial image to each other image in the subset of images 210 (e.g., image1 . . . imageN or image1 through imageN) to determine those images that should be paired with the initial image.

When the pairing factor includes a temporal limiting factor, the pairing module 212 may compare a timestamp (e.g., timestamp data 204) of the initial image to the timestamp of each of the other images in the subset of images 210. When a difference between the timestamp of the initial image and the other image being compared is less than a predetermined value, the image is selected for feature matching. The predetermined value for the temporal limiting factor may be a configurable amount of time. Example amounts of time may be 1 millisecond, 1 second, 10 seconds, 1 minute, 10 minutes, 1 hour or another value.

Alternatively, when the pairing factor includes a temporal limiting factor, the pairing module 212 may compare a timestamp of the initial image to the timestamp of each of the other images in the subset of images 210 and generate an index or matrix for all of the timestamps. The pairing module 212 may select a predetermined number of images that are closest in time to the initial image. The predetermined number of images may be 10, 20, 50, 100 or another number of images.

When the pairing factor includes a geographic limiting factor, the pairing module 212 may compare a location (e.g., position data 203) of the initial image to the location of each of the other images in the subset of images 210. When a difference between the location of the initial image and the other image being compared is less than a predetermined value, the image is selected for feature matching. The difference between locations may be a Euclidean distance or a navigational distance along one or more road or pedestrian segments or routes. The predetermined value for the temporal limiting factor may be a configurable amount of distance. Example amounts of time may be 1 foot, 1 meter, 10 meters, 100 feet, 100 meters, or another value.

When the pairing factor includes a geographic limiting factor, the pairing module 212 may compare a heading (e.g., position data 203) of the initial image to the heading of each of the other images in the subset of images 210. When a difference between the heading of the initial image and the other image being compared is less than a predetermined value, the image is selected for feature matching. The difference between headings may be an arithmetic difference in degrees or radians. The predetermined value for the temporal limiting factor may be a configurable heading value. Example heading values may be 10 degrees, 20 degrees, 70 degrees, or another value.

Alternatively, when the pairing factor includes a geographic limiting factor, the pairing module 212 may compare a location of the initial image to the timestamp of each of the other images in the subset of images 210 and generate an index or matrix for all of the locations or distances therebetween. The pairing module 212 may select a predetermined number of images that are closest in location to the initial image. The predetermined number of images may be 10, 20, 50, 100 or another number of images.

The pairing module 212 supplies the limited set of images, or index thereof, to the image module 213. The image module 213 reduces the images or image descriptors previously received from the feature extraction module 211 according to the limited index provided by the pairing module 212. Alternatively, the pairing module 212 may be only path between the feature extraction module 211 and the image module 213. That is, rather than the feature extraction module 211 send all pairwise combinations to the image module 213, which are later reduced based on the information provided by the pairing module 212, only the pairwise combinations selected by the pairing module 212 are provided by the image module 213.

The image module 213 is configured to calculate point matches based on the set of neighboring images and the positional information. In other words, the image module 213 performs feature matching among the limited set of neighboring images provided by the pairing module 212.

The image module 213 determines when one or more image descriptors of one image matches one or more image descriptors of a neighboring image. Two image descriptors match when the associated numerical values are within a predetermined range. Matching image descriptors allows the alignment or spatial correlation of the associated images for building the point cloud. In other words, the image module 213 may identify key points in pairwise combination of images where one or more descriptors in the two images, effectively for the same position for a physical entity in the 3D space, are the same or similar, but dissimilar from the other the other image descriptors associated with the images so the key points are identifiable.

The mapper module 215 is configured to construct a three-dimensional point cloud (e.g., point cloud 217) for at least a portion of the geographic area, from the point matches, using the image descriptors from the set of neighboring images. In one example, the construction includes a bundle adjustment algorithm in which the point matches are defined and refined based on the scene geometry, the parameters of the relative motion, and the optical characteristics of the camera that collected the images. The three-dimensional point cloud is inferred from the relative positions of the image data 201 within the subset of images 210 as well as the position data 203. The three-dimensional point cloud includes or is otherwise associated with the image descriptors from the subset of image data 210. The three-dimensional point cloud may include image descriptors from the point matches determined by the image module 213 and/or the key points in pairwise combination of images where one or more descriptors in the two images are matching or similar.

Once the three-dimensional point cloud is created, portions of the three-dimensional point cloud may be outputted as localization data 231 and used in various applications. The localization data 231 may be utilized to calculate position (e.g., of the mobile device 122) by comparing subsequently collected data (e.g., camera images or LIDAR data) with the point cloud to determine the location from which the subsequently collected data was collected.

One other specific application may be VPS. For example, a camera pose may be calculated by comparing point features extracted from a query image, subsequently collected, to the point features in the three-dimensional point cloud, which operates as a reference 3D point cloud model of the scene. The term subsequently collected means images collected after the three-dimensional point cloud has been created and/or modified.

When a query image, subsequently collected, is submitted for pose estimation, similar descriptors are extracted from the query image, then compared to the descriptors in the three-dimensional point cloud. Each descriptor from the query image has a 2D pixel position, while each descriptor in the cloud has a 3D world coordinate, so that matched feature pairs provide a set of pixel-to-point correspondences. An estimate for camera position may be triangulated or otherwise calculated which is geometrically consistent with the pixel-point correspondences.

Another specific application may be navigation, or augmented reality enhanced navigation, where subsequently collected camera images, are aligned to the spatial representation of the real world or the physical world, using the three-dimensional point cloud. Users may experience AR on the mobile device 122 as overlays of route information, displays of nearby restaurants and points of interest (POIs), and 3D scene models to represent objects on the other sides of walls or other physical barriers.

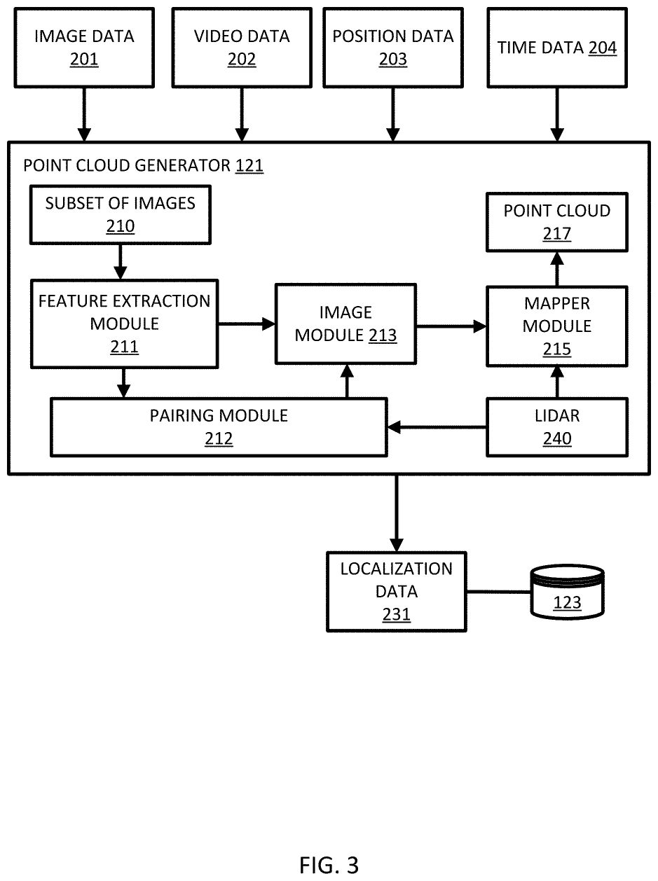

FIG. 3 illustrates a second embodiment of a point cloud controller for the system of FIG. 1. Components and features described with respect to other figures may be applied in a similar fashion to the second embodiment of FIG. 3. In the second embodiment, a second source of data is added to the point cloud generator 121. The second source may be a distance-based or three-dimensional data source such as LIDAR. In various implementations, the second source of data may be applied to the three-dimensional point cloud before or during the point cloud generation process of the point cloud generator 121. The following implementations may be performed individually or in any combination so that the second source of data is applied before the point cloud generation process, during the point cloud generation processor, or both before and during the point cloud generation process.

For example, FIG. 3 illustrates that LIDAR data 240 is provided to mapper module 215 during the point cloud generation process. In this example, the pairing module 212 limits the pairing of the images and/or associated image descriptors, as described above. The pairing module 212 select specific pairs of the subset of images 210, or associated image descriptors, from the point cloud generator 121 using the pairing factor, which may include temporal and/or geographic limiting factors. Using the paired images, the mapper module 215 is configured to modify the LIDAR data 240, which is an existing point cloud, for at least a portion of the geographic area, from the point matches, using the image descriptors from the set of neighboring images. The three-dimensional point cloud is generated from the existing LIDAR data 240 using the relative positions of the image data 201 within the subset of images 210 as well as the position data 203. The image descriptors from the subset of image data 210 are inserted into the LIDAR data 240. The resulting three-dimensional point cloud may include image descriptors from the point matches determined by the image module 213 and/or the key points in pairwise combination of images where one or more descriptors in the two images are matching or similar.

Because there is an approximate correspondence between image data 201 and the LIDAR data 240, when image descriptors are extracted from an image, the image descriptors can be assigned to the 3D point in the LIDAR data 240 for the corresponding pixel. The resulting point cloud is far denser than those achieved through SfM. This provides a richer set of features to match against when performing feature matching during online image registration.

FIG. 3 also illustrates that the LIDAR data 240 is provided to the pairing module 212. The LIDAR data 240 in this example may included both ranging data and jointly captured source imagery. The source image may be associated with the camera position and orientation measured directly from the ranging data. These images may be paired with other images at the pairing module 212 using any of the techniques or examples described herein, including a paring factor that facilitates the pairing of images based on one or more of a comparison of timestamps, a comparison of geographic position, a comparison headings, or a combination of any of these comparisons.

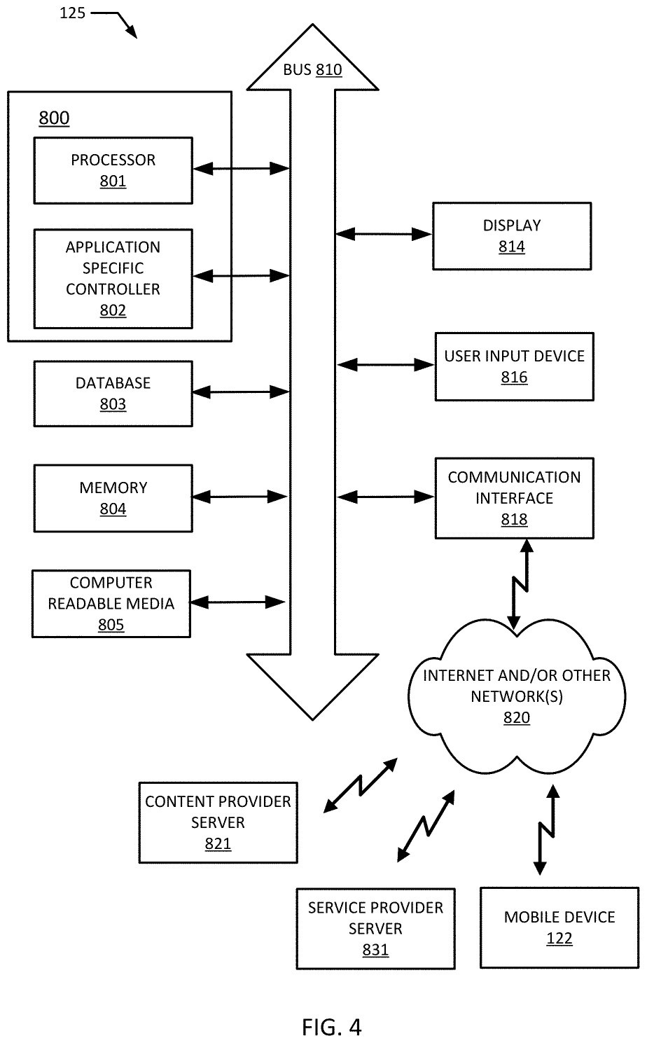

FIG. 4 illustrates an example server 125 for the system of FIG. 1. The server 125 may include a bus 810 that facilitates communication between a controller (e.g., the point cloud generator 121) that may be implemented by a processor 801 and/or an application specific controller 802, which may be referred to individually or collectively as controller 800, and one or more other components including a database 803, a memory 804, a computer readable medium 805, a display 814, a user input device 816, and a communication interface 81 connected to the internet and/or other networks 820. The contents of database 803 are described with respect to database 123. The server-side database 803 may be a master database that provides data in portions to the database 903 of the mobile device 122. Additional, different, or fewer components may be included.

The memory 804 and/or the computer readable medium 805 may include a set of instructions that can be executed to cause the server 125 to perform any one or more of the methods or computer-based functions disclosed herein. In a networked deployment, the system of FIG. 4 may alternatively operate or as a client user computer in a client-server user network environment, or as a peer computer system in a peer-to-peer (or distributed) network environment. It can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. While a single computer system is illustrated, the term “system” shall also be taken to include any collection of systems or sub-systems that individually or jointly execute a set, or multiple sets, of instructions to perform one or more computer functions.

The server 125 may be in communication through the network 820 with a content provider server 821 and/or a service provider server 831. The server 125 may provide the point cloud to the content provider server 821 and/or the service provider server 831. The content provider may include device manufacturers that provide location-based services associated with different locations POIs that users may access. The service provider server 831 may provide a cloud service for one or more aspect of the point cloud generator 121. For example, the feature extraction module 211, image module 213, and/or mapper module 215 may be performed by a COLMAP server.

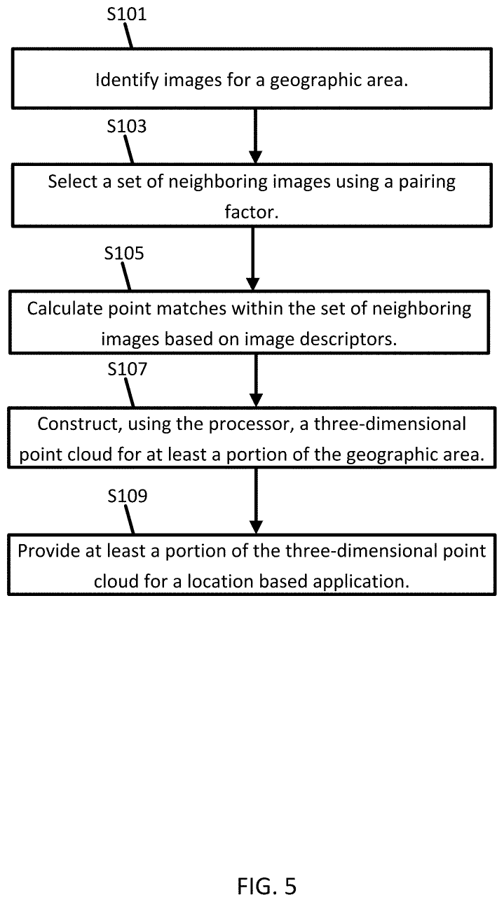

FIG. 5 illustrates an example flow chart for the server 125 of FIG. 4. Portions of this process may be performed by another device such as mobile device 122, the content provider server 821 and/or the service provider server 831. Additional, different, or fewer acts may be provided.

At act S101, the controller 800 identifies images for a geographic area. The images may be all of the images geocoded with locations within the geographic area. The images may be all of the images stored in memory 804 or computer readable media 805. Alternatively, the controller 800 may select particular images by comparing the geocodes or other locations data indexed along with the images.

At act S103, the controller 800 selects a set of neighboring images using a pairing factor. The controller 800 may filter the images from act S101. The controller 800 may select the neighboring images using any of the pairing techniques herein, which may include one or more geographic limiting criteria and one or more temporal limiting criteria. In one alternative, the neighboring images are images from a single video stream (e.g., neighboring at least in time) or from multiple video streams or images sources from different locations nearby each other (e.g., neighboring at least in position).

At act S105, the controller 800 calculates point matches within the set of neighboring images based on image descriptors. The controller 800 may extract image descriptors stored along with the image data of the set of neighboring data and identify matches from among the image descriptors. The matches may between two or more of the set of neighboring images or the actual image descriptors contained therein. Two image descriptors match when they have the same values or values within a predetermined range. The controller 800 may deem two images to be matches when a predetermined quantity of image descriptors are matches. The predetermined quantity of matching image descriptors may be 1, 2, 10, or another number. The predetermined quantity of matching image descriptors may be 1%, 2% or 5% of the image descriptors in one of the images under analysis.

At act S107, the controller 800 constructs, or augments, a three-dimensional point cloud for at least a portion of the geographic area. In some examples, the point cloud is created entirely based on the image data from the matched images in the set of neighboring images. In other examples, an existing point cloud is augmented or modified based on the point matches. That is, image information is added to the point cloud in response to matches. In either case, the image information from the set of neighboring images determined from the pairing technique is applied to a resultant point cloud (e.g., point cloud 217).

At act S109, the controller 800 provides at least a portion of the resultant point cloud to a location based application. The location based application may calculate a location of a device that captured a subsequent image. For example, an image (e.g., collected by camera 102) is compared to the resultant point cloud in order to determine the position from which the subsequent image was taken. The determination may be based on the distance and camera angle based on relative distances between points in the resultant point cloud. The location based application may include calculation of a pose angle for the device that collected the subsequent image. The controller may calculate the pose angle by comparing point features extracted from subsequent image to those in the resultant point cloud model of the geographic area.

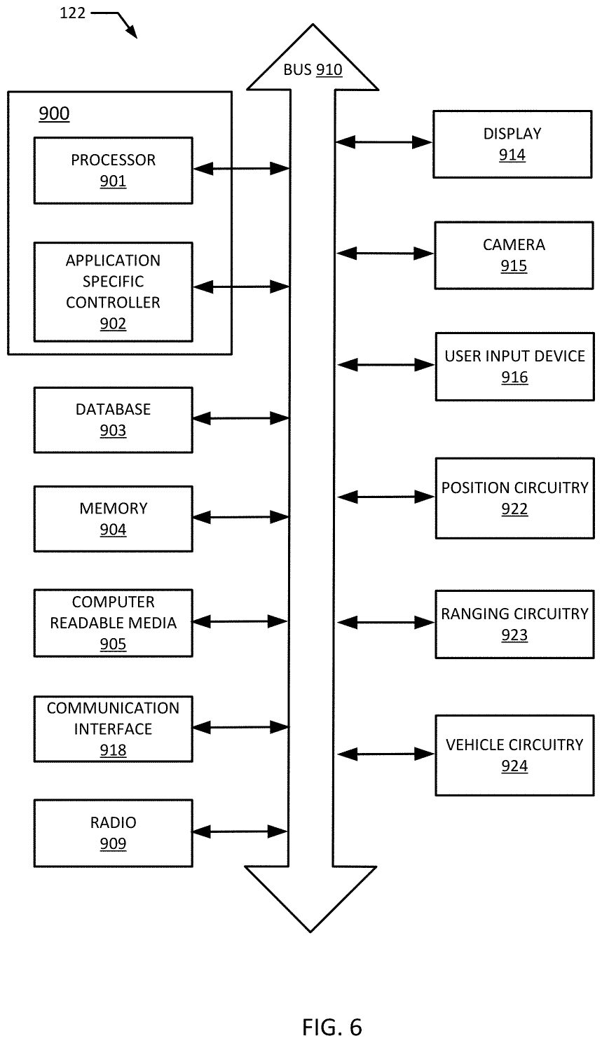

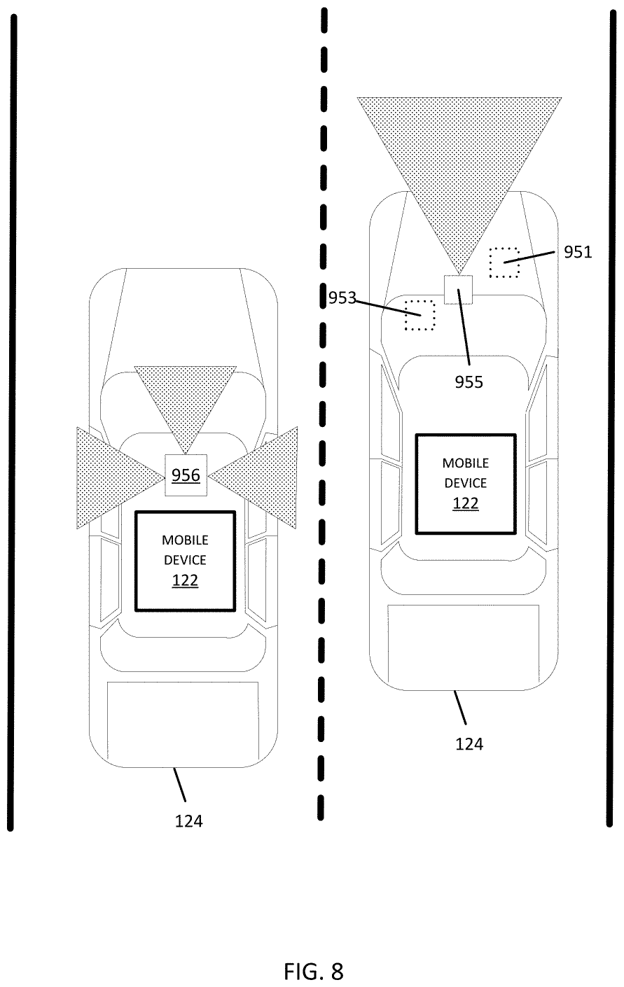

FIG. 6 illustrates an example mobile device 122 for the system of FIG. 1. The mobile device 122 may include a bus 910 that facilitates communication between a controller (e.g., the point cloud generator 121) that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a camera 915, a user input device 916, position circuitry 922, ranging circuitry 923, and vehicle circuitry 924. The contents of the database 903 are described with respect to database 123. The device-side database 903 may be a user database that receives data in portions from the database 903 of the mobile device 122. The communication interface 918 connected to the internet and/or other networks (e.g., network 820 shown in FIG. 4). The vehicle circuitry 924 may include any of the circuitry and/or devices described with respect to FIG. 8. Additional, different, or fewer components may be included.

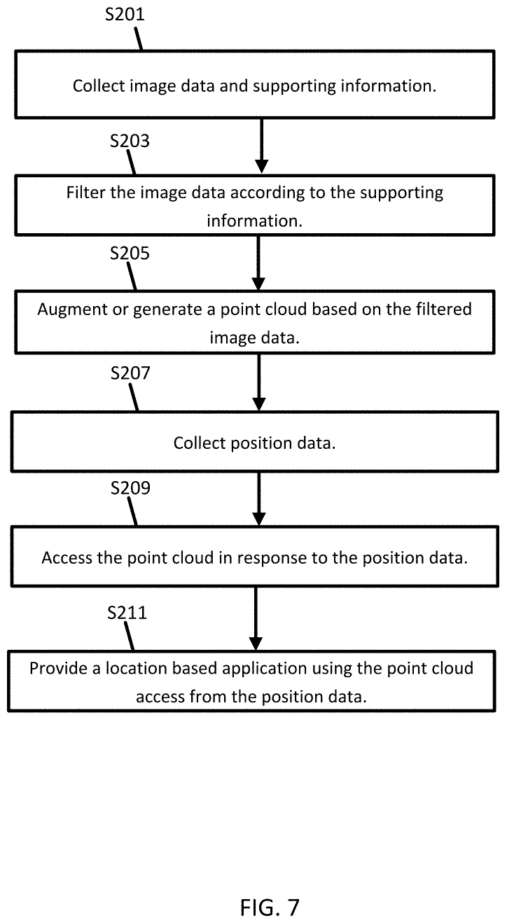

FIG. 7 illustrates an example flow chart for the mobile device of FIG. 6. One portion of the flowchart (e.g., S201-S205) describes creation of the point cloud and another portion of the flowchart (e.g., S207-S211) describe use of the point cloud. Portions of this process may be performed by another device such as the server 125, the content provider server 821 and/or the service provider server 831. Additional, different, or fewer acts may be included.

At act S201, the controller 900 collect image data and supporting information. The image data may be collected by camera 915 as still images or video images. The supporting information may include position information determined by the position circuitry 922 or the ranging circuitry 923. The supporting information may include time data recorded in connection with the position information.

At act S203, the controller 900 filters the image data according the supporting information. The controller 900 may iterate through the set of images, selecting the images one at a time for analysis. For example, when the supporting information is position, the controller 900 removes images that are not within a particular distance to the geographic area in the selected image under analysis. When the supporting information is time, the controller 900 removes the images that are not within a particular time span of the image under analysis.

At act S205, the controller 900 is configured to augment or generate a point cloud (e.g., point cloud 217) based on the filtered image data. As described herein, the point cloud may be created through the spatial relationship of the filtered images. That is, the filtered images and their spatial locations make up the point cloud. In other examples, an existing point cloud is modified using the image data from the filtered images. The point cloud may be stored with a reference to a corresponding geographic location so that the point cloud from multiple point clouds available.

The following acts, acts S207-211, may be performed after the point cloud has been created or modified. At act S207, the controller 900 collects position data for a current position of the mobile device 122. The position data may be based on GNSS measurements taken by position circuitry 922. The position data may be based on a position derived from range data from ranging circuitry 923.

At act S209, the controller 900, in response to the position data, accesses the point cloud, or a portion thereof. The controller 900 may use the geographic location used to index the point cloud or multiple point clouds.

At act S211, the controller 900 provides a location based service or application using the point cloud access from the position data, for example in a localization or position calculation technique based on a comparison of locally collected sensor to the access point cloud accessed in S209. The location based service or application may provide one or more indicia or computer generated objects overlaid on an image using the access point cloud accessed in S209. The location based service or application may include any of the other examples described herein, including the following examples related to vehicle 124.

FIG. 8 illustrates an exemplary vehicle 124 associated with the system of FIG. 1 for providing location based services or application using the point clouds described herein as well as collecting data for such services or applications and/or the generation of the point clouds described herein. The vehicles 124 may include a variety of devices that collect position data as well as other related sensor data for the surroundings of the vehicle 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively or additionally, the one or more detectors or sensors may include an accelerometer built or embedded into or within the interior of the vehicle 124. The vehicle 124 may include one or more distance data detection device or sensor, such as a LI DAR device. The distance data detection sensor may generate point cloud data. The distance data detection sensor may include a laser range finder that rotates a mirror directing a laser to the surroundings or vicinity of the collection vehicle on a roadway or another collection device on any type of pathway. The distance data detection device may generate the trajectory data. Other types of pathways may be substituted for the roadway in any embodiment described herein.

A connected vehicle includes a communication device and an environment sensor array for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server. The network may be the Internet or connected to the internet.

The sensor array may include one or more sensors configured to detect surroundings of the vehicle 124. The sensor array may include multiple sensors. Example sensors include an optical distance system such as LiDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to the point cloud other geographic data received from geographic database 123 and the server 125 and driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to the point cloud or other geographic data received from geographic database 123 and the server 125 and driving commands or navigation commands.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to the point cloud or other geographic data received from geographic database 123 and the server 125 and driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the point cloud or other geographic data received from geographic database 123 and the server 125 and driving commands or navigation commands.

The controller 900 may communicate with a vehicle ECU which operates one or more driving mechanisms (e.g., accelerator, brakes, steering device). Alternatively, the mobile device 122 may be the vehicle ECU, which operates the one or more driving mechanisms directly.

The controller 800 or 900 may include a routing module including an application specific module or processor that calculates routing between an origin and destination. The routing module is an example means for generating a route in response to the anonymized data to the destination. The routing command may be a driving instruction (e.g., turn left, go straight), which may be presented to a driver or passenger, or sent to an assisted driving system. The display 914 is an example means for displaying the routing command. The mobile device 122 may generate a routing instruction based on the anonymized data.

The routing instructions may be provided by display 914. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

The mobile device 122 may plan a route through a road system or modify a current route through a road system in response to the request for additional observations of the road object. For example, when the mobile device 122 determines that there are two or more alternatives for the optimum route and one of the routes passes the initial observation point, the mobile device 122 selects the alternative that passes the initial observation point. The mobile devices 122 may compare the optimal route to the closest route that passes the initial observation point. In response, the mobile device 122 may modify the optimal route to pass the initial observation point.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The geographic database 123 may include map data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the map data. The map data may include structured cartographic data or pedestrian routes. The map data may include map features that describe the attributes of the roads and intersections. The map features may include geometric features, restrictions for traveling the roads or intersections, roadway features, or other characteristics of the map that affects how vehicles 124 or mobile device 122 flor through a geographic area. The geometric features may include curvature, slope, or other features. The curvature of a road segment describes a radius of a circle that in part would have the same path as the road segment. The slope of a road segment describes the difference between the starting elevation and ending elevation of the road segment. The slope of the road segment may be described as the rise over the run or as an angle. The geographic database 123 may also include other attributes of or about the roads such as, for example, geographic coordinates, street names, address ranges, speed limits, turn restrictions at intersections, and/or other navigation related attributes (e.g., one or more of the road segments is part of a highway or toll way, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The databases may also contain one or more node data record(s) which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, and maneuver data.

The geographic database 123 may contain at least one road segment database record 304 (also referred to as “entity” or “entry”) for each road segment in a particular geographic region. The geographic database 123 may also include a node database record (or “entity” or “entry”) for each node in a particular geographic region. The terms “nodes” and “segments” represent only one terminology for describing these physical geographic features, and other terminology for describing these features is intended to be encompassed within the scope of these concepts. The geographic database 123 may also include location fingerprint data for specific locations in a particular geographic region.

The radio 909 may be configured to radio frequency communication (e.g., generate, transit, and receive radio signals) for any of the wireless networks described herein including cellular networks, the family of protocols known as WiFi or IEEE 802.11, the family of protocols known as Bluetooth, or another protocol.

The memory 804 and/or memory 904 may be a volatile memory or a non-volatile memory. The memory 804 and/or memory 904 may include one or more of a read only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 818 and/or communication interface 918 may include any operable connection. An operable connection may be one in which signals, physical communications, and/or logical communications may be sent and/or received. An operable connection may include a physical interface, an electrical interface, and/or a data interface. The communication interface 818 and/or communication interface 918 provides for wireless and/or wired communications in any now known or later developed format.

The input device 916 may be one or more buttons, keypad, keyboard, mouse, stylus pen, trackball, rocker switch, touch pad, voice recognition circuit, or other device or component for inputting data to the mobile device 122. The input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

The ranging circuitry 923 may include a LIDAR system, a RADAR system, a structured light camera system, SONAR, or any device configured to detect the range or distance to objects from the mobile device 122.

The positioning circuitry 922 may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network devices.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory.

Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method for three-dimensional point cloud generation, the method comprising:
identifying a plurality of images corresponding to a geographic area and including image descriptors, wherein two or more of the plurality of images adaptable into a spatial relationship based on positional information associated with the plurality of images;
selecting a set of neighboring images from the plurality of images using a pairing factor;
calculating, using a processor, point matches within the set of neighboring images based on the image descriptors; and
constructing, using the processor, a three-dimensional point cloud for at least a portion of the geographic area, from the point matches and the spatial relationship, using the image descriptors from the set of neighboring images.

2. The method of claim 1, wherein the pairing factor is a temporal factor and the set of neighboring images are neighbors in time having timestamps within a predetermined range.

3. The method of claim 2, wherein the predetermined range is a time range defining an amount of time between the timestamps of the set of neighboring images or a sequence range defining a quantity of images collected in sequence.

4. The method of claim 1, wherein the pairing factor is a spatial factor and the set of neighboring images are neighbors in geometric space based on the positional information, wherein the positional information includes position coordinates and/or heading values.

5. The method of claim 1, wherein selecting a set of neighboring images from the plurality of images using a pairing factor further comprises:
identifying an initial image;
performing comparisons of other images in the plurality of images to the initial image using the pairing factor; and
identifying the set of neighboring images in response to the comparison.

6. The method of claim 1, further comprising:
receiving the plurality of images from a plurality of types of sources.

7. The method of claim 1, wherein the positional information includes geographic coordinates and at least one angle.

8. The method of claim 1, wherein the positional information includes, at least in part, light detection and ranging (LIDAR) data.

9. The method of claim 8, wherein the set of neighboring images are selected in response to the LIDAR data.

10. The method of claim 1, further comprising:
calculating a three-dimensional position for a probe using the three-dimensional point cloud.

11. The method of claim 1, further comprising:
receiving sensor data; and
overlaying one or more objects on an output image using the three-dimensional point cloud and the output image.

12. An apparatus comprising:
a memory including a plurality of images corresponding to a geographic area, wherein the plurality of images include image descriptors adaptable into a spatial relationship based on positional information associated with the plurality of images;
a feature extractor configured to select a set of neighboring images from the plurality of images using a pairing factor;
an image module configured to calculate point matches based on the set of neighboring images and the positional information; and
a mapper configured to construct a three-dimensional point cloud for at least a portion of the geographic area, from the point matches, using the image descriptors from the set of neighboring images.

13. The apparatus of claim 12, wherein the pairing factor is a temporal factor and the set of neighboring images are neighbors in time having timestamps within a predetermined range.

14. The apparatus of claim 13, wherein the predetermined range is a time range defining an amount of time between the timestamps of the set of neighboring images or a sequence range defining a quantity of images collected in sequence.

15. The apparatus of claim 12, wherein the pairing factor is a spatial factor and the set of neighboring images are neighbors in geometric space based on the positional information.

16. The apparatus of claim 12, wherein the feature extractor is configured to identify an initial image, compare other images in the plurality of images to the initial image using the pairing factor, and identify the set of neighboring images in response to the comparison.

17. The apparatus of claim 12, wherein the set of neighboring images are selected in response to the LIDAR data.

18. The apparatus of claim 12, wherein a three-dimensional position for a probe is determined using the three-dimensional point cloud.

19. A non-transitory computer readable medium including instructions that when executed are configured to perform:
identifying a plurality of images corresponding to a geographic area, wherein the plurality of images include image descriptors adaptable into a spatial relationship based on positional information associated with the plurality of images;
selecting a set of neighboring images from the plurality of images using a pairing factor;
calculating point matches based on the set of neighboring images and the positional information;
constructing a three-dimensional point cloud for at least a portion of the geographic area, from the point matches, using the image descriptors from the set of neighboring images;
receiving sensor data from a mobile device; and
calculating a position based on the sensor data and the three-dimensional point cloud.

20. The non-transitory computer readable medium of claim 19, wherein the pairing factor includes a time component to limit the set of neighboring images and a position component to limit the set of neighboring images.
